(19) United States
(12) Patent Application Publication
(10) Pub. No.: US 2019/0228729 A1
(43) Pub. Date: Jul. 25, 2019

(54) DISPLAY DEVICE AND METHOD FOR CONTROLLING DISPLAY DEVICE

(71) Applicant: SHARP KABUSHIKI KAISHA, Sakai City, Osaka (JP)

(72) Inventors: TAKUYA OKAMOTO, Sakai City (JP); KENJI MAEDA, Sakai City (JP)

(21) Appl. No.: 16/331,268

(22) PCT Filed: Jul. 21, 2017
(86) PCT No.: PCT/JP2017/026548

§ 371 Date: Mar. 7, 2019

(30) Foreign Application Priority Data
Sep. 23, 2016 (JP) 2016-185970

(51) Int. Cl. G09G 3/36; G02B 27/01; H04N 13/296

(52) U.S. Cl. CPC G09G 3/3685; H04N 13/204; H04N 13/296; G02B 27/017

(57) ABSTRACT

Provided is a display device which can quickly show an updated image to a user. A head mounted display (1) includes a display driving section (21) and a backlight (24). The display driving section secures a pause period between (i) a first display driving period during which display driving is carried out with respect to a first display region for a left eye and (ii) a second display driving period during which display driving is carried out with respect to a second display region for a right eye. The backlight does not irradiate the first display region and the second display region with light during a first period of the pause period. The backlight irradiates the first display region and the second display region with light during a second period of the pause period, the second period following the first period.

### TECHNICAL FIELD

The present invention relates to a display device.

### BACKGROUND ART

As a display device for showing different images (i.e., stereoscopic image) to left and right eyes of a user, there exists a head mounted display which is used by being worn on a user's head.

Patent Literature 1 discloses a head mounted type stereoscopic image display device, in which an image for a left eye and an image for a right eye are alternately displayed on a single display device in a time-sharing manner. In order to prevent crosstalk between left and right images, such a head mounted type stereoscopic image display device includes a shutter for alternately switching between a left eye's view and a right eye's view.

### CITATION LIST

### Patent Literature

[Patent Literature 1]

Japanese Patent Application Publication Tokukaihei No. 6-102469 (1994)

### SUMMARY OF INVENTION

### Technical Problem

A technique disclosed in Patent Literature 1 requires a shutter for preventing crosstalk. This necessitates synchronization control between the shutter and image display. This also makes a configuration of a display device complicated, leading to an increase in weight of the display device which is to be worn on a head.

One approach to eliminate the need for the shutter is to divide a display screen into left and right ones, so that a region seen via a left eye is separated from a region seen via a right eye. However, in a case where a backlight is always turned on, a user may see, due to absence of the shutter, an image which is being rewritten. In contrast, in a case where the backlight is turned on after completion of update of all pixels in the display screen, a timing is undesirably delayed at which the user can view updated left and right images.

An object of an aspect of the present invention is to provide a display device which can quickly show an updated image to a user.

### Solution to Problem

A display device in accordance with an aspect of the present invention includes: a display panel having (i) a first display region for a first eye and (ii) a second display region for a second eye; a display driving section which is configured to write image data into the display panel; and a backlight which is configured to irradiate the display panel with light, the display driving section being configured to secure a pause period during which display driving is paused, the pause period being secured between (i) a first display driving period during which first image data for the first eye is written into the first display region and (ii) a second display driving period during which second image data for the second eye is written into the second display region, the backlight not irradiating the first display region and the second display region with light during a first period of the pause period, the backlight irradiating the first display region and the second display region with light during a second period of the pause period, the second period following the first period.

A method of controlling a display device in accordance with an aspect of the present invention is a method of controlling a display device which includes (i) a display panel having a first display region for a first eye and a second display region for a second eye and (ii) a backlight which is configured to irradiate the display panel with light, the method including the steps of: securing a pause period during which display driving is paused, the pause period being secured between (i) a first display driving period during which first image data for the first eye is written into the first display region and (ii) a second display driving period during which second image data for the second eye is written into the second display region; causing the backlight not to irradiate the first display region and the second display region with light during a first period of the pause period; and causing the backlight to irradiate the first display region and the second display region with light during a second period of the pause period, the second period following the first period.

### Advantageous Effects of Invention

An aspect of the present invention makes it possible to quickly show an updated image to a user.

### BRIEF DESCRIPTION OF DRAWINGS

FIG. 1 is a block diagram illustrating a configuration of a head mounted display in accordance with Embodiment 1 of the present invention.

FIG. 2 is a view schematically illustrating an internal configuration of the head mounted display in accordance with Embodiment 1 of the present invention.

FIG. 3 is a view schematically illustrating respective planar configurations of a display panel and a backlight in accordance with Embodiment 1 of the present invention.

FIG. 4 is a timing chart illustrating how image data is displayed in Embodiment 1 of the present invention.

FIG. 5 is a flowchart illustrating a process carried out by a host in accordance with Embodiment 1 of the present invention.

FIG. 6 is a flowchart illustrating a process carried out by a display section in accordance with Embodiment 1 of the present invention.

FIG. 7 is a timing chart illustrating how image data is displayed in Embodiment 2 of the present invention.

FIG. 8 is a flowchart illustrating a process carried out by a host in accordance with Embodiment 2 of the present invention.

FIG. 9 is a flowchart illustrating a process carried out by a display section in accordance with Embodiment 2 of the present invention.

### DESCRIPTION OF EMBODIMENTS

### Embodiment 1

(Configuration of Head Mounted Display)

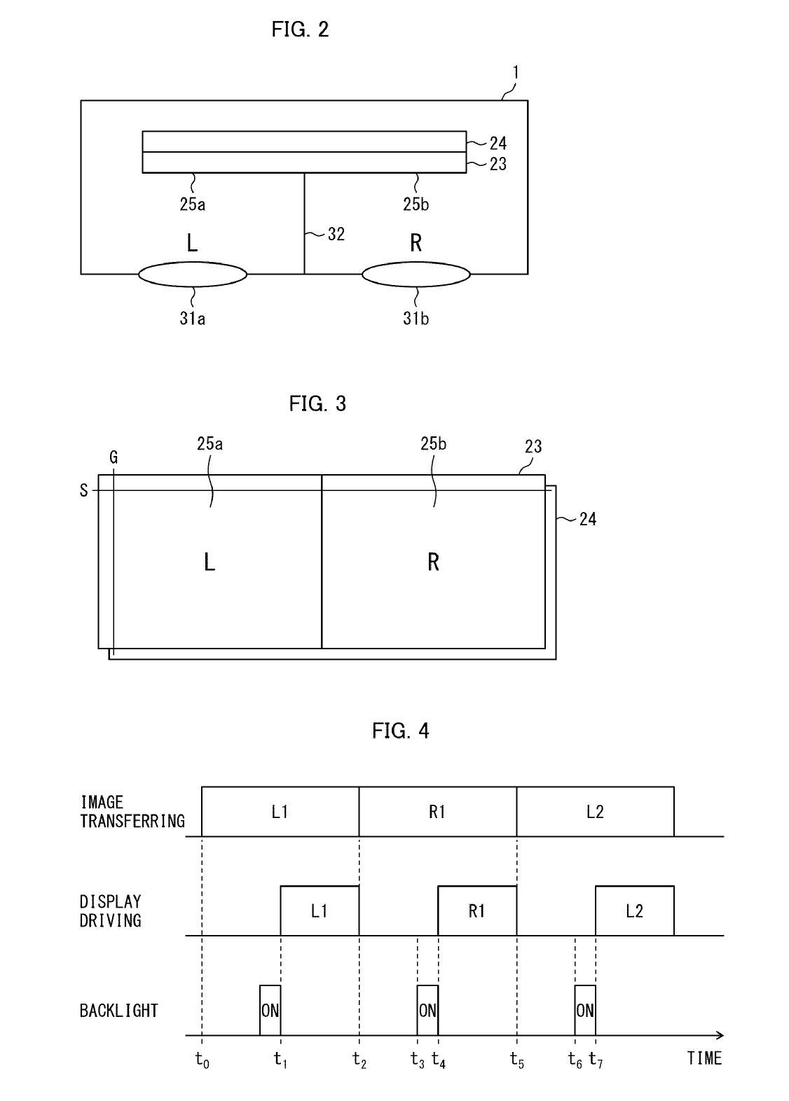

FIG. 2 is a view schematically illustrating an internal configuration of a head mounted display in accordance with Embodiment 1. A head mounted display 1 is a display device which a user can wear on his/her head. The head mounted display 1 includes (i) a lens part 31a, for a left eye, through which the user looks into the head mounted display 1 with his/her left eye and (ii) a lens part 31b, for a right eye, through which the user looks into the head mounted display 1 with his/her right eye. Note that each of the lens parts 31a and 31b can include at least one lens. The head mounted display 1 includes, in its housing, a display panel 23 and a backlight 24. A space in the head mounted display 1 is partitioned by a partition 32. Therefore, (i) the user can see, through his/her left eye, only a display region 25a of the display panel 23 and (ii) the user can see, through his/her right eye, only a display region 25b of the display panel 23, the display region 25a being for a left eye and the display region 25b being for a right eye.

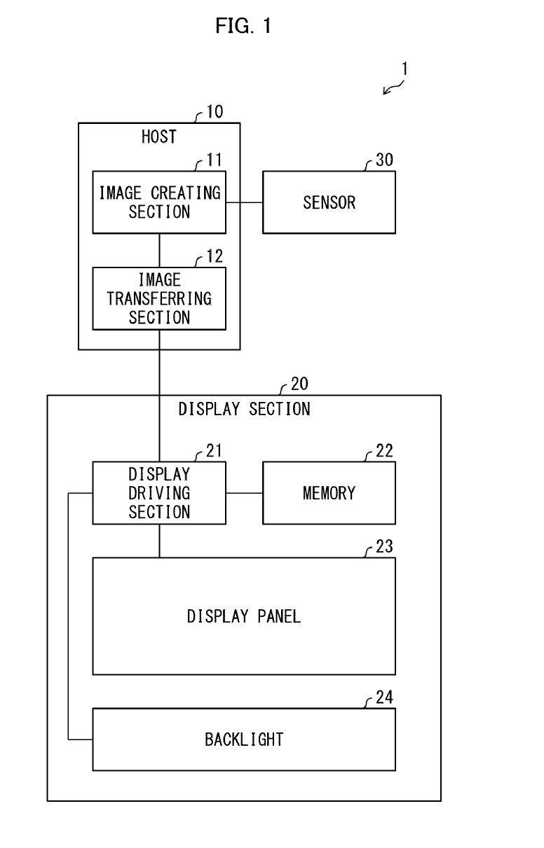

FIG. 1 is a block diagram illustrating a configuration of the head mounted display in accordance with Embodiment 1. The head mounted display 1 includes a host 10, a display section 20, and a sensor 30.

The sensor 30 is a sensor for detecting a user's movement. The sensor 30 is, for example, an acceleration sensor or a gyroscopic sensor. The sensor 30 detects a change in direction toward which the user has changed his/her head, and then supplies information on the user's movement (i.e., the direction of the head) to the host 10.

The host 10 is s circuit for controlling the head mounted display 1. The host 10 includes an image creating section 11 and an image transferring section 12. The host 10 receives the information on the user's movement from the sensor 30, and then supplies the information thus received to the image creating section 11.

The image creating section 11 creates, based on the information on the user's movement supplied by the sensor 30, image data to be displayed on the display section 20. The image creating section 11 can be realized by a circuit. The image creating section 11 can alternatively be realized by a program, a central processing unit (CPU) for executing the program, and/or a graphics processing unit (GPU) for executing the program. For example, the image creating section 11 identifies, based on the information on the user's movement, a user's location and a user's direction in a virtual reality space. The image creating section 11 creates the image data in accordance with (i) 3D data in the virtual reality space and (ii) the user's location and the user's direction which are thus identified. The image data thus created indicates an image, which represents a user's view in the virtual reality space. The image creating section 11 creates, as the image data, (i) image data for a left eye (i.e., image data for a first eye) and (ii) image data for a right eye (i.e., image data for a second eye). The image data for the left eye and the image data for the right eye each indicate, for example, an image in which a parallax between left and right eyes is considered. The image creating section 11 supplies, to the image transferring section 12, the image data for the left eye and the image data for the right eye which are thus created.

The image transferring section 12 alternately transfers, to the display section 20, the image data for the left eye and the image data for the right eye, at a predetermined timing.

The display section 20, serving as a display device, includes a display driving section 21, a memory 22, the display panel 23, and the backlight 24. The display section 20 supplies image data thus received to the display driving section 21.

The display driving section 21 is a circuit which is configured to control respective operations of the display panel 23 and the backlight 24. The display driving section 21 writes, into the memory 22, the image data supplied from the host 10. The display driving section 21 reads out the image data from the memory 22 at a predetermined timing in synchronization with display update, and then writes the image data thus read out into the display panel 23. The display driving section 21 controls the backlight 24 to be turned on and off at a predetermined timing.

The memory 22 temporarily stores therein the received image data, until the image data is read out from the memory 22 so as to be written into the display panel 23. The memory 22 has a capacity, which can be smaller in size than, for example, the image data for the left eye (or the image data for the right eye).

FIG. 3 is a view schematically illustrating respective planar configurations of the display panel and the backlight.

The display panel 23 includes a plurality of pixels, into which the image data is to be written. The display panel 23 displays an image indicated by the image data, by changing an amount by which each of the plurality of pixels transmits light emitted from the backlight 24. According to Embodiment 1, the display panel 23 includes a single display screen which includes the display regions 25a and 25b. The display regions 25a and 25b each include a plurality of liquid crystal pixels. The display panel 23 includes (i) a plurality of scanning signal lines G arranged on the display screen and (ii) a plurality of data signal lines S arranged on the display screen. FIG. 3 illustrates, for convenience, (a) one of the plurality of scanning signal lines G and (b) one of the plurality of data signal lines S. The plurality of scanning signal lines G extend in a longitudinal direction so as to be arranged, side by side, in a lateral direction. The plurality of data signal lines S extend in the lateral direction so as to be arranged, side by side, in the longitudinal direction. Note that the plurality of data signal lines S are shared by the display regions 25a and 25b. The image data is supplied to the plurality of pixels, via the respective plurality of data signal lines S. Note that the plurality of scanning signal lines G are scanned, in sequence, from the left toward the right. Embodiment 1 is, however, not limited as such. Alternatively, the plurality of scanning signal lines G can be scanned, in sequence, from a center of the display screen toward outsides of the display screen.

Image data for one (1) frame indicates an image which is to be displayed on a single display screen. The image data for one (1) frame is made up of (i) image data for a left eye and (ii) image data for a right eye. The image data for the left eye is written into the plurality of pixels of the display region 25a, and is then displayed in the display region 25a. Similarly, the image data for the right eye is written into the plurality of pixels of the display region 25b, and is then displayed in the display region 25b.

The backlight 24 is a light source, provided on a rear side of the display panel 23, which irradiates the display panel 23 with light. The backlight 24 is shared by the display regions 25a and 25b. The backlight 24 simultaneously irradiates both the display regions 25a and 25b with light. In other words, (i) both the display regions 25a and 25b are irradiated with light while the backlight 24 is turned on and (ii) none of the display regions 25a and 25b are irradiated with light while the backlight 24 is turned off.

(Timing Chart)

FIG. 4 is a timing chart illustrating how the image data is displayed. Each of lateral axes shown in FIG. 4 indicates time. The host 10 alternately transfers, to the display section 20, image data for a left eye and image data for a right eye. Image data for one (1) frame is composed of (i) the image data for the left eye and (ii) the image data for the right eye. Embodiment 1 deals with a case where a frame rate is 60 Hz. It follows that one (1) frame period is approximately 16.4 ms. Note, however, that the frame rate is not limited to 60 Hz.

Image data L1 for a left eye is transferred to the display section 20 during a period of time (first transfer period) from time t0 to time t2. Image data R1 for a right eye is transferred to the display section 20 during a period of time (second transfer period) from the time t2 to time t5.

The display driving section 21 temporarily stores, in the memory 22, the received image data L1. The display driving section 21 starts to write the image data L1 in the memory 22 into the display panel 23 (i.e., the display driving section 21 starts to carry out display driving) at time t1. The time t1 indicates time at which a predetermined period of time has elapsed since the image data L1 started to be transferred. Note that a speed of display driving is faster than that of image transfer. Therefore, a start of display driving is delayed for a certain period of time from a start of image transfer so that the display driving section 21 can supply a set of data to the display panel 23 upon receipt of a last set of data of the image data L1 (i.e., upon receipt of the set of data corresponding to a rightmost column of the display region 25a). This causes (i) the image data L1 to be transferred and (ii) the image data L1 to finish being written into the display panel 23, at substantially the same timing (i.e., at the time t2). Of course, there exists a time lag between an end of transfer and an end of writing. Therefore, an end of a first display driving period, during which the image data L1 is used, can overlap with a start of the second transfer period, during which the image data R1 is transferred.

The image data R1 starts to be transferred at the time t2. The display driving section 21 temporarily stores, as with the image data L1, the received image data R1 in the memory 22. However, display driving (i.e., writing of image data into the display panel 23) is paused during a period of time (i.e., pause period) from the time t2 to time t4. The pause period includes (i) a first period (a period of time from the time t2 to time t3) during which the backlight 24 is turned off and (ii) a second period (a period of time from the time t3 to the time t4) during which the backlight 24 is turned on.

The backlight 24 carries out intermittent driving, in which the backlight 24 is repeatedly turned on and off. From the time t1 at which the image data L1 starts to be written into the display panel 23, the backlight 24 is kept turned off until the time t3. In other words, the backlight 24 is turned off (i) during the first display driving period (a period of time from the time t1 to the time t2), during which display driving is carried out with respect to the display region 25a, and (ii) during the first period (a period of time from the time t2 to the time t3) of the pause period during which display driving is paused. The backlight 24 is then turned on during the second period (a period of time from the time t3 to the time t4) of the pause period, which second period follows the first period. That is, during a period of time from the time t3 to the time t4, the user views an image displayed in the display region 25a, which image has been updated by the image data L1. Note that the backlight 24 is shared by the display regions 25a and 25b. Therefore, during the period of time from the time t3 to the time t4, the user also views an image displayed in the display region 25b, which image has not been updated yet.

After the backlight 24 is turned off, display update in the display region 25b is started at the time t4 with use of the image data R1. At the time t5, the transferring of the image data R1 is finished, and then writing of the image data R1 into the display panel 23 is finished. Image data L2, for a left eye, in a next frame also starts to be transferred at the time t5. A period of time from the time t5 to time t7 is a pause period during which display driving of the display panel 23 is paused. The backlight is turned on during a latter period of time (a period of time from time t6 to the time t7) of the pause period. During a period of time from the time t6 to the time t7, the user views an image displayed in the display region 25b, which image has been updated by the image data R1 (together with the image displayed in the display region 25a, which image has been updated by the image data L1). After the backlight 24 is turned off, display update in the display region 25a is started at the time t7 with use of the image data L2.

According to the example shown in FIG. 4, the first transfer period (a period of time from the time t0 to the time t2) and the second transfer period (a period of time from the time t2 to the time t5) are each approximately 8.3 ms. According to the example, the writing of the image data L1 is started after approximately 4.2 ms has elapsed since the image data L1 started to be transferred. That is, the pause period (a period of time from the time t2 to the time t4 or a period of time from the time t5 to the time t7), secured between the first display driving period and a second display driving period, is approximately 4.2 ms. The first display driving period (a period of time from the time t1 to the time t2) and the second display driving period (a period of time from the time t4 to the time t5) are each set to approximately 4.2 ms. Every lighting period (a period of time from the time t3 to the time t4 or a period of time from the time t6 to the time t7), during which the backlight 24 is turned on, is approximately 1 ms. An image for one (1) frame is transferred at a speed equivalent to 60 Hz, which is identical to the frame rate. In contrast, display driving of an image for one (1) frame is carried out at a speed equivalent to 120 Hz, which is twice the frame rate. Note that these numerical values are illustrative only, and can be therefore changed. For example, display driving can be carried out at a speed faster than the speed equivalent to 120 Hz. Every lighting period of the backlight can be made longer or shorter.

Note here that it takes a certain period of time from a time when data is written into liquid crystal pixels to a time when a direction of liquid crystals is changed to an intended state. Response time of the liquid crystal pixels is, for example, approximately 4 ms. The response time indicates a time required for the liquid crystal pixels to undergo a transition from black to white. It follows that, if the backlight is turned on before the liquid crystal pixels complete such a transition, then the user irresistibly sees a changing image.

In Embodiment 1, the display section 20 controls the backlight 24 to be turned on, after time required for states of the liquid crystal pixels to undergo respective transitions has elapsed since writing of a last pixel of the display region 25a was completed. This makes it possible to display an appropriate image, instead of the user irresistibly seeing a changing image. Note that a part of a period of time, during which the backlight 24 is turned on, can slightly overlap with a subsequent display driving period. This is because (i) it takes time for states of the liquid crystal pixels to undergo respective transitions and (ii) pixels at rightmost or leftmost edge in a display region (i.e., pixels at an end of the user's view), which pixels are less important, are updated first during the display driving period.

If the backlight is turned on for the first time after completion of (i) transfer of image data for one (1) frame (i.e., transfer of the image data L1 and the image data R1) and (ii) display driving of the image data, then it takes at least one (1) frame period from the time when the image data starts to be transferred to the time when the user views an updated image. The head mounted display changes an image in accordance with a user's direction. Therefore, if it takes a long period of time from transferring of the image data to displaying of the image data, then a change in image cannot follow a change in direction of the user. This causes the user to feel uncomfortable.

In view of the circumstances, according to Embodiment 1, the display driving section 21 secures a pause period between (i) respective display driving periods for the display region 25a and (ii) respective display driving periods for the display region 25b. The backlight 24 is turned on during a second period of the pause period, which second period follows the first period. This makes it possible that an image of the image data L1 is visible to the user in advance, while the image data R1 is being transferred, before one (1) frame period has elapsed since the image data was started to be transferred. Similarly, it is possible that the image data R1 is visible to the user, before one (1) frame period has elapsed since the image data R1 started to be transferred. This allows the display section 20 to display, at a high speed, an image after image data starts to be transferred. Ultimately, the head mounted display 1 causes an image, which changes in accordance with a user's movement, to be visible to the user.

Furthermore, the head mounted display 1 employs the backlight 24 which is shared by the display regions 25a and 25b. This eliminates the need for individually providing an individually-controllable backlight for each display region. It is thus possible to (i) simplify the head mounted display 1 in terms of structure and control and (ii) reduce the weight of the head mounted display 1.

(Process Flow)

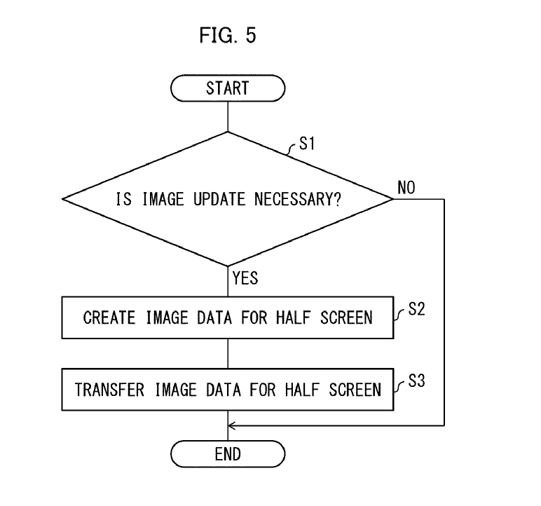

FIG. 5 is a flowchart illustrating a process carried out by the host. The image creating section 11 determines whether or not image update is necessary (S1), based on (i) information supplied from the sensor 30 and/or (ii) a frame rate. In a case where, for example, the information supplied from the sensor 30 indicates that a user's direction has been changed, the image creating section 11 determines that image update is necessary. Alternatively, the image creating section 11 can (i) determine to carry out image update (image creation) at a predetermined timing which is based on the frame rate or the like and (ii) create an image with reference to information, which has been received from the sensor 30 in a case where an image is created. In such a case, the sensor 30 supplies, at regular intervals, information to the host 10. Note that, in a case of video playback or the like, the image creating section 11 can determine, based on contents of a video, that image update is necessary independently of the information supplied from the sensor 30. In a case where the display section 20 needs to receive image data (i.e., display update) for each predetermined period, the image creating section 11 can determine that image update is necessary for each predetermined period.

In a case where image update is necessary (Yes in S1), the image creating section 11 creates image data for a left eye or image data for a right eye, which image data needs to be updated (S2). The image transferring section 12 transfers, to the display section 20, image data (i.e., the image data for the left eye or the image data for the right eye) for a half screen (½ frame) corresponding to one display region which needs to be updated (S3). Subsequently, in a case where the other display region also needs image update, the image transferring section 12 transfers, to the display section 20, image data for a half screen corresponding to the other display region. In a case where no image update is necessary (No in S1), respective processes for image creation (S2) and image transfer (S3) are skipped. Based on a set frame rate, the host 10 repeats the steps S1 through S3 at a predetermined timing.

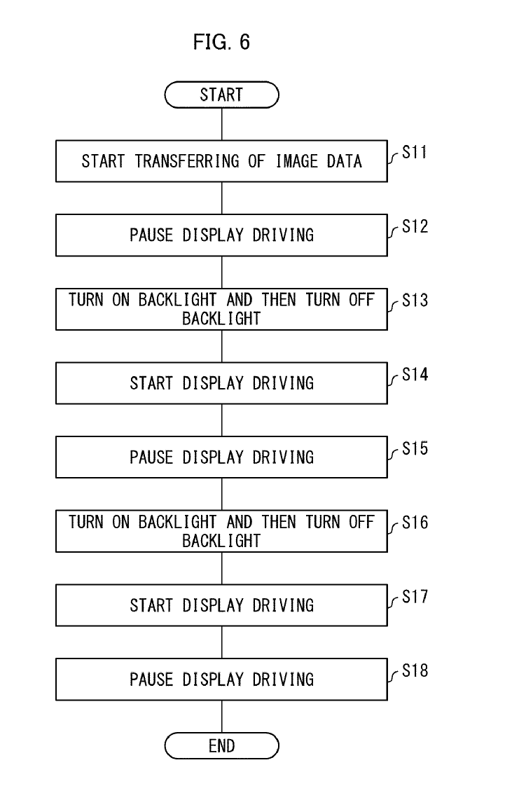

FIG. 6 is a flowchart illustrating a process carried out by the display section. Image data for the half screen, which corresponds to one display region, starts to be transferred to the display section 20 (S11). Upon completion of display driving of a previous frame, the display driving section 21 causes the display panel 23 to pause display driving (S12). After a predetermined period of time has elapsed since immediately previous display driving was completed, the display driving section 21 controls the backlight 24 to be turned on (S13). Subsequently, the display driving section 21 controls the backlight 24 to be turned off after another predetermined period of time has elapsed. At a timing at which the display driving section 21 has received a half of image data for one half screen, the display driving section 21 starts to read out, from the memory 22, the image data thus received for the one half screen. The display driving section 21 starts to carry out display driving with respect to the display panel 23, and writes the image data for the one half screen into the display panel 23 (S14). Upon completion of writing of the image data for the one half screen, the display driving section 21 causes the display panel 23 to pause display driving (S15).

Subsequently to the image data for the half screen corresponding to the one display region, the image data for the half screen, which corresponds to the other display region, starts to be transferred. After a predetermined period of time has elapsed since immediately previous display driving was completed, the display driving section 21 controls the backlight 24 to be turned on (S16). Subsequently, the display driving section 21 controls the backlight 24 to be turned off after another predetermined period of time has elapsed. At a timing at which the display driving section 21 has received a half of image data for the other half screen, the display driving section 21 starts to read out, from the memory 22, the image data thus received for the other half screen. The display driving section 21 starts to carry out display driving with respect to the display panel 23, and writes the image data for the other half screen into the display panel 23 (S17). Upon completion of writing of the image data for the other half screen, the display driving section 21 causes the display panel 23 to pause display driving (S18).

Image transfer and display driving can be skipped, in a case where no image update is necessary (i.e., in a case where an image does not change). Note that, even in a case where image transfer and display driving are skipped, the display driving section 21 controls the backlight 24 to be turned on at predetermined intervals so that an image is displayed.

### Embodiment 2

The following description will discuss Embodiment 2 of the present invention. For convenience, members having functions identical to those of members discussed in Embodiment 1 are given the same reference signs, and descriptions of such members are omitted. A head mounted display 1 in accordance with Embodiment 2 is configured as illustrated in FIGS. 1 through 3. In Embodiment 2, not only display driving, but also image transfer is carried out at a speed faster than a speed equivalent to a frame rate.

(Timing Chart)

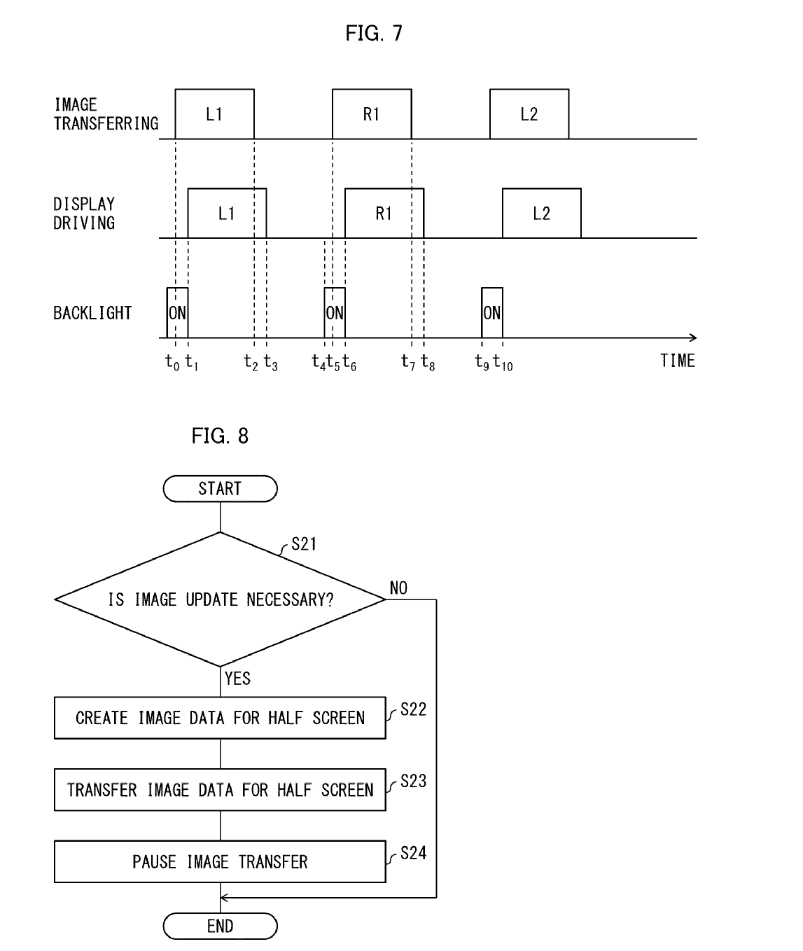

FIG. 7 is a timing chart illustrating how image data is displayed. Each of lateral axes shown in FIG. 7 indicates time. A host 10 alternately transfers, to a display section 20, image data for a left eye and image data for a right eye. Embodiment 2 deals with a case where the frame rate is 60 Hz.

During a period of time from time t0 to time t2 (i.e., first transfer period), image data L1 for a left eye is transferred to the display section 20 at a transfer speed equivalent to 120 Hz. Image transfer is caused to pause during a period of time (i.e., first transfer pause period) from the time t2 to time t5. Image data R1 for a right eye is transferred to the display section 20 during a period of time (i.e., second transfer period) from the time t5 to time t7. After the time t7, a period of time (i.e., second transfer pause period) during which the image transferring is paused is also secured until image data L2, for a left eye, in a next frame starts to be transferred.

A display driving section 21 temporarily stores the received image data L1 in a memory 22. Then, the display driving section 21 starts to write the image data L1 into a display panel 23 (i.e., starts to carry out display driving) at time t1, at which a backlight 24 is turned off. Note that, in a case where the backlight 24 is turned off earlier, the display driving section 21 can start to write the image data L1 into the display panel 23 immediately after receipt of the image data L1. All that is required is that a timing at which display driving of the image data L1 ends never comes earlier than a timing at which transferring of the image data L1 ends. Note here that display driving is also carried out at a speed equivalent to 120 Hz. The display driving section 21 terminates, at time t3, the display driving in a display region 25a for a left eye. The display driving section 21 causes the display panel 23 to pause display driving during a period of time from the time t3 to time t6, at which next display driving starts to be carried out with respect to a display region 25b for a right eye.

The backlight 24 carries out intermittent driving, in which the backlight 24 is repeatedly turned on and off. From the time t1 at which the image data L1 starts to be written into the display panel 23, the backlight 24 is kept turned off until time t4. In other words, the backlight 24 is turned off during (i) a first display driving period (a period of time from the time t1 to the time t3), during which display driving is carried out with respect to the display region 25a, and (ii) during a first period (a period of time from the time t3 to the time t4) of a pause period during which display driving is paused. The backlight 24 is then turned on during a second period (a period of time from the time t4 to the time t6) of the pause period, which second period follows the first period. That is, during a period of time from the time t4 to the time t6, a user views an image displayed in the display region 25a, which image has been updated by the image data L1. Note that the backlight 24 is shared by the display regions 25a and 25b. Therefore, during the period of time from the time t4 to the time t6 the user also views an image, displayed in the display region 25b, which image has not been updated yet.

The second image data R1 starts to be transferred at the time t5. The display driving section 21 temporarily stores, as with the image data L1, the received image data R1 in the memory 22.

After the backlight 24 is turned off, display update in the display region 25b is started from the time t6 with use of the image data R1. The transferring of the image data R1 is finished at the time t7. Subsequently, writing of the image data R1 into the display panel 23 is finished at time t8. On and after the time t8, pause periods are similarly secured during which the display panel 23 is caused to pause display driving. The backlight is turned on during a period of time (from time t9 to time t10) of the pause period, which period is immediately before display driving. During a period of time from the time t9 to the time t10, the user views an image displayed in the display region 25b, which image has been updated by the image data R1 (together with the image displayed in the display region 25a, which image has been updated by the image data L1). After the backlight 24 is turned off, display update in the display region 25a is started at the time t10 with use of the image data L2.

According to the example shown in FIG. 7, the first transfer period (a period of time from the time t0 to the time t2) and the second transfer period (a period of time from the time t5 to the time t7) are each approximately 4.2 ms. The transfer pause period (a period of time from the time t2 to the time t5) between the first transfer period and the second transfer period is set to approximately 4.2 ms. The pause period (a period of time from the time t3 to the time t6), secured between the first display driving period and a second display driving period, is approximately 4.2 ms. The first display driving period (a period of time from the time t1 to the time t3) and the second display driving period (a period of time from the time t6 to the time t8) are each approximately 4.2 ms. Every lighting period (a period of time from the time t4 to the time t6 or a period of time from the time t9 to the time t10), during which the backlight 24 is turned on, is approximately 1 ms. Note that these numerical values are illustrative only, and can be therefore changed. For example, display driving can be carried out at a speed faster than the speed equivalent to 120 Hz. Every lighting period of the backlight can be made longer or shorter.

It is preferable that a period of time from the time when immediately previous display driving is started to the time when the backlight 24 is turned on (i.e., to the time when the second period starts) is set to be equal to or longer than response time of liquid crystal pixels. This causes the backlight to be turned on after a state of at least a part (i.e., a pixel which is scanned first) of liquid crystal pixels, in a display region, which was subjected to display driving is sufficiently changed. Moreover, it is preferable that a period of time from the time when immediately previous display driving is finished to the time when the backlight 24 is turned on (i.e., to the time when the second period starts) is set to be equal to or longer than the response time of the liquid crystal pixels. This causes the backlight to be turned on after a state of all liquid crystal pixels, in a display region, which were subjected to display driving is sufficiently changed. The above preferences are common to all the embodiments, but the embodiments are not limited as such.

(Process Flow)

FIG. 8 is a flowchart illustrating a process carried out by the host. An image creating section 11 determines, based on information supplied by a sensor 30, whether or not image update is necessary (S21). In a case where image update is necessary (Yes in S21), the image creating section 11 creates image data for a left eye or image data for a right eye, which image data needs to be updated (S22). An image transferring section 12 transfers, to the display section 20, image data (i.e., the image data for the left eye or the image data for the right eye) for a half screen (½ frame) corresponding to one display region which needs to be updated (S23). After completion of transferring of the image data for the half screen, the image transferring section 12 pauses image transferring (S24). Subsequently, in a case where the other display region also needs image update, the image transferring section 12 transfers, to the display section 20, image data for a half screen corresponding to the other display region, as in the step S23. In a case where no image update is necessary (No in S21), respective processes for image creation (S22) and image transfer (S23) are skipped. Based on a set frame rate, the host 10 repeats the steps S21 to S24 at a predetermined timing.

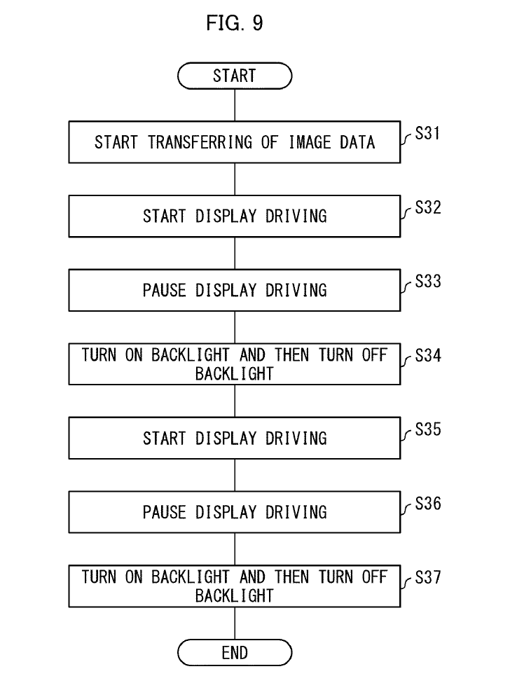

FIG. 9 is a flowchart illustrating a process carried out by the display section. Image data for the half screen, which corresponds to one display region, starts to be transferred to the display section 20 (S31). Upon receipt of image data for one half screen, the display driving section 21 temporarily stores the image data in the memory 22. In synchronization with a synchronizing timing of the display panel 23, the display driving section 21 sequentially reads out, from the memory 22, the image data for the one half screen. The display driving section 21 starts to carry out display driving with respect to the display panel 23, and writes the image data for the one half screen into the display panel 23 (S32). Upon completion of writing of the image data for the one half screen, the display driving section 21 causes the display panel 23 to pause display driving (S33). After a predetermined period of time has elapsed since display driving of one display region was completed, the display driving section 21 controls the backlight 24 to be turned on (S34). Subsequently, the display driving section 21 controls the backlight 24 to be turned off after another predetermined period of time has elapsed.

Subsequently to the image data for the half screen corresponding to one display region, the image data for the half screen, which corresponds to the other display region, starts to be transferred. The display driving section 21 temporarily stores image data for the other half screen in the memory 22. In synchronization with the synchronizing timing of the display panel 23, the display driving section 21 sequentially reads out, from the memory 22, the image data for the other half screen. The display driving section 21 starts to carry out display driving with respect to the display panel 23, and writes the image data for the other half screen into the display panel 23 (S35). Upon completion of writing of the image data for the other half screen, the display driving section 21 causes the display panel 23 to pause display driving (S36). After a predetermined period of time has elapsed since display driving of the other display region was completed, the display driving section 21 controls the backlight 24 to be turned on (S37). Subsequently, the display driving section 21 controls the backlight 24 to be turned off after another predetermined period of time has elapsed.

Image transfer and display driving can be skipped, in a case where no image update is necessary (i.e., in a case where an image does not change). Note that, even in a case where image transfer and display driving are skipped, the display driving section 21 controls the backlight 24 to be turned on at predetermined intervals so that an image is displayed.

In Embodiment 2, the display section 20 starts to carry out display driving with use of image data, immediately after or relatively quickly after receipt of the image data (the image data L1 or R1). In a case where the frame rate is 60 Hz, it normally takes one (1) frame period (1/60 seconds) for each of image transferring and display driving to be carried out. In Embodiment 2, image transferring and display driving are carried out at a high speed as compared with a speed corresponding to the frame rate. This makes it possible to secure a pause period for display driving, between (i) the first display driving period for the display region 25a and (ii) the second display driving period for the display region 25b. The display driving section 21 controls the backlight 24 to be turned off during the first period of the pause period, and then controls the backlight 24 to be turned on during the second period, which follows the first period. This makes it possible to display an appropriate image, instead of showing a changing image to the user. Furthermore, the display section 20 can display an image at a high speed (within a half frame period according to the above example) after image data starts to be transferred. This ultimately allows the head mounted display 1 to show, to the user, an image which changes in accordance with a user's movement.

Note that the memory 22 can be realized by a line memory having a capacity for one (1) pixel line, in a case where the display driving section 21 starts display driving upon receipt of image data.

[Recap]

A display device (head mounted display 1, display section 20) in accordance with a first aspect of the present invention is configured to include: a display panel (23) having (i) a first display region for a first eye and (ii) a second display region for a second eye; a display driving section (21) which is configured to write image data into the display panel; and a backlight (24) which is configured to irradiate the display panel with light, the display driving section being configured to secure a pause period during which display driving is paused, the pause period being secured between (i) a first display driving period during which first image data for the first eye is written into the first display region and (ii) a second display driving period during which second image data for the second eye is written into the second display region, the backlight not irradiating the first display region and the second display region with light during a first period of the pause period, the backlight irradiating the first display region and the second display region with light during a second period of the pause period, the second period following the first period.

According to the configuration, the display device includes the backlight, which is shared by the first display region and the second display region. This allows a reduction in weight of the display device. Furthermore, the pause period, during which display driving is paused, includes (i) the first period, during which the backlight does not carry out light irradiation, and (ii) the second period, which follows the first period and during which the backlight carries out light irradiation. This makes it possible to appropriately show, to a user, not a changing image but an updated image. Moreover, since the backlight irradiates the first display region with light prior to the second display driving period, during which display driving of the second display region is carried out, it is possible to quickly show, to the user, an updated image displayed in the first display region.

The display device in accordance with a second aspect of the present invention can be configured to further include, in the first aspect of the present invention, a memory (22) in which the image data is to be stored, the display driving section storing, in the memory, the first image data and the second image data which are alternately transferred to the display driving section.

The display device in accordance with a third aspect of the present invention can be configured such that, in the second aspect of the present invention, the display driving section is configured to read out the image data stored in the memory, and then write the image data thus read out into the display panel; and the first display driving period is shorter than a first transfer period, during which the first image data is transferred to the display driving section.

With the configuration, it is possible to secure a long pause period between the first display driving period and the second display driving period, instead of reducing the frame rate.

The display device in accordance with a fourth aspect of the present invention can be configured such that, in the first or second aspect of the present invention, a transfer pause period is secured during which transferring of the image data is paused, the transfer pause period being secured between (i) a first transfer period during which the first image data is transferred to the display driving section and (ii) a second transfer period during which the second image data is transferred to the display driving section.

The configuration allows the first display driving period to be secured earlier, and in turn allows the second period to be secured earlier. This makes it possible to show an updated image to the user more quickly after the first image data starts to be transferred.

The display device in accordance with a fifth aspect of the present invention can be configured such that, in any one of the first through fourth aspects of the present invention, before the second display driving period starts, the backlight terminates irradiation of the first display region and the second display region with light.

The configuration makes it possible to prevent the user from viewing a changing image.

The display device in accordance with a sixth aspect of the present invention can be configured such that, in any one of the first through fifth aspects of the present invention, the display panel includes liquid crystal pixels; and a period of time, from a start of the first display driving period to a start of the second period, is equal to or longer than response time of the liquid crystal pixels.

With the configuration, the backlight carries out light irradiation after a state of at least part of liquid crystal pixels in the first display region is sufficiently changed. This makes it possible to appropriately show an updated image to the user.

The display device in accordance with a seventh aspect of the present invention can be configured such that, in the sixth aspect of the present invention, a period of time, from an end of the first display driving period to the start of the second period, is equal to or longer than the response time of the liquid crystal pixels.

With the configuration, the backlight carries out light irradiation after a state of all the liquid crystal pixels in the first display region is sufficiently changed. This makes it possible to appropriately show an updated image to the user.

The display device in accordance with an eighth aspect of the present invention can be configured to be suitable to be worn by a user and to further include, in any one of the first through seventh aspects of the present invention, a sensor which is configured to detect a movement of the user; and an image creating section which is configured to create the image data in accordance with the movement of the user.

The configuration makes it possible to show, to the user, an image which changes in accordance with, for example, a user's movement.

A method of controlling a display device in accordance with a ninth aspect of the present invention is a method of controlling a display device which includes (i) a display panel having a first display region for a first eye and a second display region for a second eye and (ii) a backlight which is configured to irradiate the display panel with light, the method including the steps of: securing a pause period during which display driving is paused, the pause period being secured between (i) a first display driving period during which first image data for the first eye is written into the first display region and (ii) a second display driving period during which second image data for the second eye is written into the second display region; causing the backlight not to irradiate the first display region and the second display region with light during a first period of the pause period; and causing the backlight to irradiate the first display region and the second display region with light during a second period of the pause period, the second period following the first period.

The present invention is not limited to the foregoing embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Head mounted display (display device)
10: Host
11: Image creating section
12: Image transferring section
20: Display section (display device)
21: Display driving section
22: Memory
23: Display panel
24: Backlight
25a: Display region for left eye
25b: Display region for right eye
30: Sensor

1. A display device, comprising:
a display panel having (i) a first display region for a first eye and (ii) a second display region for a second eye;
a display driving section which is configured to write image data into the display panel; and
a backlight which is configured to irradiate the display panel with light,
the display driving section being configured to secure a pause period during which display driving is paused, the pause period being secured between (i) a first display driving period during which first image data for the first eye is written into the first display region and (ii) a second display driving period during which second image data for the second eye is written into the second display region,
the backlight not irradiating the first display region and the second display region with light during a first period of the pause period,
the backlight irradiating the first display region and the second display region with light during a second period of the pause period, the second period following the first period.

2. A display device as set forth in claim 1, further comprising:
a memory in which the image data is to be stored,
the display driving section storing, in the memory, the first image data and the second image data which are alternately transferred to the display driving section.

3. The display device as set forth in claim 2, wherein:
the display driving section is configured to read out the image data stored in the memory, and then write the image data thus read out into the display panel; and
the first display driving period is shorter than a first transfer period, during which the first image data is transferred to the display driving section.

4. The display device as set forth in claim 1, wherein:
a transfer pause period is secured during which transferring of the image data is paused, the transfer pause period being secured between (i) a first transfer period during which the first image data is transferred to the display driving section and (ii) a second transfer period during which the second image data is transferred to the display driving section.

5. The display device as set forth in claim 1, wherein:
before the second display driving period starts, the backlight terminates irradiation of the first display region and the second display region with light.

6. The display device as set forth in claim 1, wherein:
the display panel includes liquid crystal pixels; and
a period of time, from a start of the first display driving period to a start of the second period, is equal to or longer than response time of the liquid crystal pixels.

7. The display device as set forth in claim 6, wherein:
a period of time, from an end of the first display driving period to the start of the second period, is equal to or longer than the response time of the liquid crystal pixels.

8. A display device as set forth in claim 1, the display device being suitable to be worn by a user, further comprising:
a sensor which is configured to detect a movement of the user; and
an image creating section which is configured to create the image data in accordance with the movement of the user.

9. A method of controlling a display device which comprises (i) a display panel having a first display region for a first eye and a second display region for a second eye and (ii) a backlight which is configured to irradiate the display panel with light,
said method comprising the steps of:
securing a pause period during which display driving is paused, the pause period being secured between (i) a first display driving period during which first image data for the first eye is written into the first display region and (ii) a second display driving period during which second image data for the second eye is written into the second display region;
causing the backlight not to irradiate the first display region and the second display region with light during a first period of the pause period; and
causing the backlight to irradiate the first display region and the second display region with light during a second period of the pause period, the second period following the first period.
